(19) United States
(12) Patent Application Publication
(10) Pub. No.: US 2014/0182618 A1
(43) Pub. Date: Jul. 3, 2014

(54) DENTAL FLOSS FILAMENT HOLDER

(71) Applicant: Javad Jafari Dehnavi, Isfahan (IR)

(72) Inventor: Javad Jafari Dehnavi, Isfahan (IR)

(73) Assignee: Javad Jafari Dehnavi, Isfahan (IR)

(21) Appl. No.: 13/730,991

(22) Filed: Dec. 29, 2012

(51) Int. Cl. A61C 15/04

(52) U.S. Cl. CPC A61C 15/043
USPC 132/325

(57) ABSTRACT

The embodiments herein provide a dental floss holder for holding dental floss filament. The dental floss holder has a floss filament for removing the tiny food particles from a space between the teeth. A handle is provided for supporting two legs holding the floss filament in a spool container enclosed with a cap. Two levers are used to hold and release the floss filament from a dispenser. The grooves are provided at the junction of two legs for passing the floss filament. The consumed floss filament is cut with a metal blade. An elastic rubber is provided to prevent an entry of water from into the floss filament. The lever is rotated in anticlockwise direction to release the floss filament for replacing the consumed floss filament with new floss filament while the lever is rotated in clockwise direction to cut the consumed floss filament with the metal blade.

### CROSS-REFERENCE TO RELATED APPLICATION

This application claims the priority under 35 USC 35 119(e) of U.S. Provisional Application Ser. No. 61/581,145 filed Dec. 29, 2011 which included by reference herein.

### BACKGROUND

1. Technical Field

The embodiments herein generally relate to hygienic devices and particularly relate to a dental hygienic device for mouth and dental care. The embodiments herein more particularly relate to a dental floss filament device for enabling an ease of flossing by the users of all ages and preventing a contamination of mouth due to hands.

2. Description of the Related Art

According to the recommendations of the dentists, the use of dental floss before brushing the teeth is necessary and a brushing alone is not capable of removing the tiny food particles from the spaces between the teeth. On one hand, most of the people do not use a dental floss due to the lack of proper tools for using dental floss and also the entry of bacteria through the contamination of the hands.

The existing dental flossing devices/dental floss apparatuses comprise a floss holder, where the floss filament is fixed and then used for cleaning the teeth. Due to the size of the dental floss device, the user experiences an inconvenience while flossing, which results in the usage of the hands for flossing. The usage of hands for flossing contaminates the mouth and makes the user vulnerable to diseases. Also, there is a wastage of filament used in the existing dental floss devices as excess filament is taken for cleaning the teeth of a user. Further, the children find difficulties in using the dental floss device due to the complexity of the usage. Also there are chances of wasting more floss filaments among the children. Many dental floss devices also create a discomfort in the mouth due to an improper design and an improper material of manufacturing.

Hence, there is a need for an improved and simple dental floss device which provides ease of flossing to the users of all ages and especially the children. There also exists a need to provide a dental floss device for reducing a contact of a hand during a cleaning of the teeth. Further, there exists a need for a dental floss device for reducing a wastage of an excess floss filament among the users. Furthermore, there is need for dental floss device which is easy to handle and enables a firm grip during a flossing process.

The abovementioned shortcomings, disadvantages and problems are addressed herein and which will be understood by reading and studying the following specification.

### OBJECT OF THE EMBODIMENTS

The primary object of the embodiments herein is to provide a dental floss holder for holding a dental floss filament.

Another object of the embodiments herein is to provide a dental floss holder which is compact and convenient to use.

Yet another object of the embodiments herein is to provide a dental floss holder provided with a dental floss having a strong tension.

Yet another object of the embodiments herein is to provide a dental floss holder which consumes a less amount of floss filament.

Yet another object of the embodiments herein is to provide a dental floss holder in which the floss filament consumed is removed easily.

These and other objects and advantages of the present invention will become readily apparent from the following detailed description taken in conjunction with the accompanying drawings.

### SUMMARY

The various embodiments herein provide a dental floss holder for holding a dental floss filament. The dental floss holder comprises a floss filament for removing the tiny food particles from a space between the teeth, at least two spaced apart legs for holding a floss filament, a handle member for supporting the at least two spaced apart legs, a spool container for securing a spool of a floss filament, at-least two levers for holding and releasing the floss filament, a dispenser for dispensing the floss filament from the spool, a plurality of segments on the handle member for conveying the floss filament, at-least one groove provided at a junction of the two legs on the handle member for passing the floss filament, a metal blade for cutting a floss filament which is consumed, an elastic rubber for preventing water from entering the floss filament while washing and a cap for enclosing the spool container. The lever of the dental floss filament holder is rotated in an anticlockwise direction to release the floss filament for replacing the floss filament which is consumed with a new floss filament and wherein the floss filament which is consumed is cut through a metal blade by rotating the lever in a clockwise direction.

According to an embodiment herein, the spaced apart legs are supported by an elongated handle member which is sized for a convenient grasping by the user and are inclined at an angle to a plane of the handle member to allow a ready positioning of the taut floss between the most hard to reach spaces of the users teeth.

According to an embodiment herein, the dental floss filament holder further comprises at least two flanges in the rout of the floss for decreasing the friction between the pieces of floss filament on each other and on handle member of the floss holder.

According to an embodiment herein, the levers of the dental floss filament holder are non-concentric spheres provided on the sides of the dispenser for applying an excessive pressure with a little force.

According to an embodiment herein, the levers of the dental floss filament holder turn a rotational movement into a linear movement through 180 degrees rotation leading to an up and down movement of the dispenser.

According to an embodiment herein, the levers of the dental floss filament holder further comprises a lifting lever rotating in the anticlockwise direction and a lowering lever rotating in a direction which is contrary to a dispenser direction. When the lifting lever rotates in the anticlockwise direction, the floss filament is released and the new floss filament is replaced as the consumed floss filament pulls the new floss filament. Similarly the new floss filament will come down in the direction contrary to the dispenser direction as the lowering lever rotates. Then the consumed floss filament is cut through the metal blade.

According to an embodiment herein, the dispenser of the dental floss filament holder further comprises a floss filament holder for holding the floss filament, one or more pullers for pulling the floss from the floss filament, one or more grooves for leading the floss filament and a guiding hole for holding the levers.

According to an embodiment herein, a cog holding the floss filament gets involved and the floss filament holder prevents the floss filament to be added from the spool, when the levers of the dental floss filament holder are rotated the floss filament holder moves down.

According to an embodiment herein, the dental floss filament holder further comprises one or more puller cogs for firming and pulling the floss filament.

According to an embodiment herein, the dental floss filament holder further comprises the guiding grooves for preventing the floss filament from being fell down from the cogs.

According to an embodiment herein, the metal blade of the dental floss filament holder is made of stainless steel.

According to an embodiment herein, the dental floss filament holder further comprises a cover for securing floss filament when not in use.

### BRIEF DESCRIPTION OF THE DRAWINGS

The other objects, features and advantages will occur to those skilled in the art from the following description of the preferred embodiment and the accompanying drawings in which:

FIG. 1 illustrates a side perspective view of the dental floss filament holder with the lever rotated in an anticlockwise direction through 180 degrees, according to one embodiment herein.

FIG. 2 illustrates a side perspective view of the dental floss filament holder with the lever in the original position, according to one embodiment herein.

FIG. 3 illustrates a cross sectional view of the dental floss filament holder, according to one embodiment herein.

FIG. 4 illustrates a front view of the dental floss filament holder, according to one embodiment herein.

FIG. 5 illustrates an exploded perspective view of the dental floss filament holder, according to one embodiment herein.

FIG. 6 illustrates a cross sectional view of the dispenser of the dental floss filament holder, according to one embodiment herein.

FIG. 7 illustrates a front perspective view of the levers of the dental floss filament holder, according to one embodiment herein.

FIG. 8 illustrates a side perspective view of the levers of the dental floss filament holder, according to one embodiment herein.

FIG. 9 illustrates a side perspective view of the legs holding floss filament, according to one embodiment herein.

FIG. 10 illustrates a side perspective view of the cover of the dental floss filament holder, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a dental floss holder for holding a dental floss filament. The dental floss holder comprises a floss filament for removing the tiny food particles from a space between the teeth, at least two spaced apart legs for holding a floss filament, a handle member for supporting the at least two spaced apart legs, a spool container for securing a spool of a floss filament, at-least two levers for holding and releasing the floss filament, a dispenser for dispensing the floss filament from the spool, a plurality of segments on the handle member for conveying the floss filament, at-least one groove provided at a junction of the two legs on the handle member for passing the floss filament, a metal blade for cutting a floss filament which is consumed, an elastic rubber for preventing water from entering the floss filament while washing and a cap for enclosing the spool container. The lever of the dental floss filament holder is rotated in an anticlockwise direction to release the floss filament for replacing the floss filament which is consumed with a new floss filament and wherein the floss filament which is consumed is cut through a metal blade by rotating the lever in a clockwise direction.

According to an embodiment herein, the spaced apart legs are supported by an elongated handle member which is sized for a convenient grasping by the user and are inclined at an angle to a plane of the handle member to allow a ready positioning of the taut floss between the most hard to reach spaces of the users teeth.

According to an embodiment herein, the dental floss filament holder further comprises at least two flanges in the rout of the floss for decreasing the friction between the pieces of floss filament on each other and on handle member of the floss holder.

According to an embodiment herein, the levers of the dental floss filament holder are non-concentric spheres provided on the sides of the dispenser for applying an excessive pressure with a little force.

According to an embodiment herein, the levers of the dental floss filament holder turn a rotational movement into a linear movement through 180 degrees rotation leading to an up and down movement of the dispenser.

According to an embodiment herein, the levers of the dental floss filament holder further comprises a lifting lever rotating in the anticlockwise direction and a lowering lever rotating in a direction which is contrary to a dispenser direction. When the lifting lever rotates in the anticlockwise direction, the floss filament is released and the new floss filament is replaced as the consumed floss filament pulls the new floss filament. Similarly the new floss filament will come down in the direction contrary to the dispenser direction as the lowering lever rotates. Then the consumed floss filament is cut through the metal blade.

According to an embodiment herein, the dispenser of the dental floss filament holder further comprises a floss filament holder for holding the floss filament, one or more pullers for pulling the floss from the floss filament, one or more grooves for leading the floss filament and a guiding hole for holding the levers.

According to an embodiment herein, a cog holding the floss filament gets involved and the floss filament holder prevents the floss filament to be added from the spool, when the levers of the dental floss filament holder are rotated the floss filament holder moves down.

According to an embodiment herein, the dental floss filament holder further comprises one or more puller cogs for firming and pulling the floss filament.

According to an embodiment herein, the dental floss filament holder further comprises the guiding grooves for preventing the floss filament from being fell down from the cogs.

According to an embodiment herein, the metal blade of the dental floss filament holder is made of stainless steel.

According to an embodiment herein, the dental floss filament holder further comprises a cover for securing floss filament when not in use.

According to an embodiment herein, the dental floss filament holder has a main part, a razor edge, the peripheral levers, a floss fixer, a cap and a floss pathway. The peripheral levers consist of two crankshafts that cause the floss holder to move up and down by turning around the bigger lever and the smaller lever to open and close the floss holder.

When the peripheral levers are turned or rotated, the floss holder moves downward. The jags/jaws that are close together hit each other and pull the floss down. The floss pathway is so narrow that the floss pathway prevents the floss movement. As the floss holder moves downward, the distant jags/jaws pull the floss to fix it. In this case, floss is unable to be separated from the groove of the top of the device. The groove prevents the separation of the floss from the jags/jaws while the floss holder moves downward.

The dental floss holder helps in reducing the use of dental floss by 80%. The holder helps to fix and replace the dental floss easily. The cap is provided to keep the floss clean.

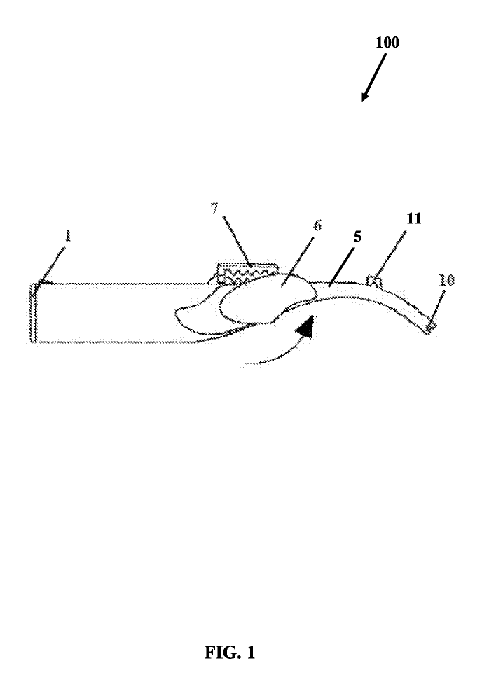

FIG. 1 illustrates a side perspective view of the dental floss filament holder with a lever rotated in an anticlockwise direction through 180 degrees, according to one embodiment herein. The dental floss filament holder 100 comprises a handle member 5 for supporting two spaced apart legs 10 (only one leg is visible in the FIG. 1), a dispenser 7 for dispensing floss filament from the spool, at-least two levers 6 (only one lever is visible in the FIG. 1) for holding and releasing the floss filament, a flange 11 provided in the rout of the floss for decreasing the friction between the pieces of floss filament on each other and on handle member of the dental floss filament holder and a cap 1 for enclosing the spool container. The levers 6 of the dental floss filament holder 100 are non-concentric spheres provided on the sides of the dispenser 7 for applying an excessive pressure with a little force. The levers 6 of the dental floss filament holder 100 turn a rotational movement into a linear movement through 180 degrees rotation leading to an up and down movement of the dispenser 7 as shown in FIG. 1. The lever 6 of the dental floss filament holder 100 is rotated in anticlockwise direction to release the floss filament for replacing the consumed floss filament with the new floss filament.

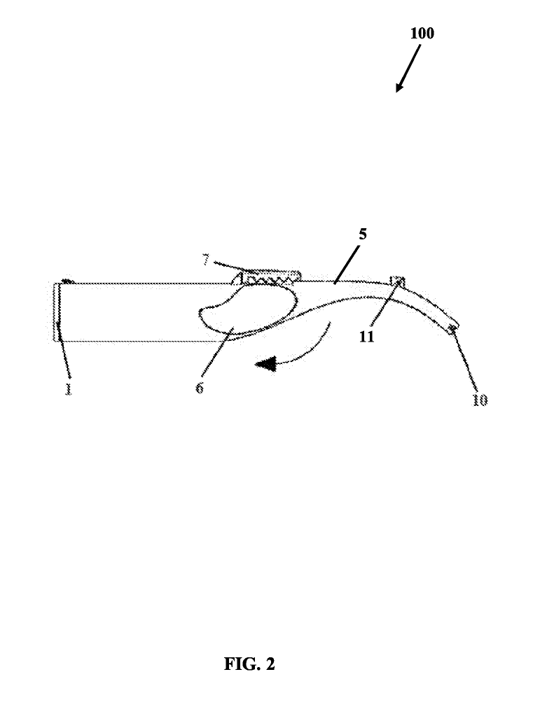

FIG. 2 illustrates a side perspective view of the dental floss filament holder with the lever in the original position, according to one embodiment herein. The dental floss filament holder 100 comprises a handle member 5 for supporting the two spaced apart legs 10, a dispenser 7 for dispensing a floss filament from the spool, at-least two levers 6 for holding and releasing the floss filament, a flange 11 provided in the rout of the floss for decreasing the friction between the pieces of floss filament on each other and on the handle member 5 of the dental floss filament holder 100 and a cap 1 for enclosing the spool container as shown in FIG. 2. The levers 6 of the dental floss filament holder 100 further comprises a lifting lever rotating in an anticlockwise direction and a lowering lever rotating in the direction contrary to the dispenser direction. When the lifting lever rotates in anticlockwise direction, the floss filament is released and the new floss filament is replaced as the consumed floss filament pulls the new floss filament. Similarly, as the lowering lever rotates, the new floss filament will come down in the direction contrary to the dispenser direction. Then the consumed floss filament is cut through the metal blade.

According to an embodiment of the present invention, when the levers 6 situated in the floss filament holding hole are rotated, the floss filament holder 100 goes down and the cog holding the floss filament gets involved and prevents the floss filament to be added by the spool.

According to an embodiment of the present invention, the floss filament is firmed/fixed and pulled through puller cogs simultaneously. The steering groove prevents the floss filament from falling down from the cogs.

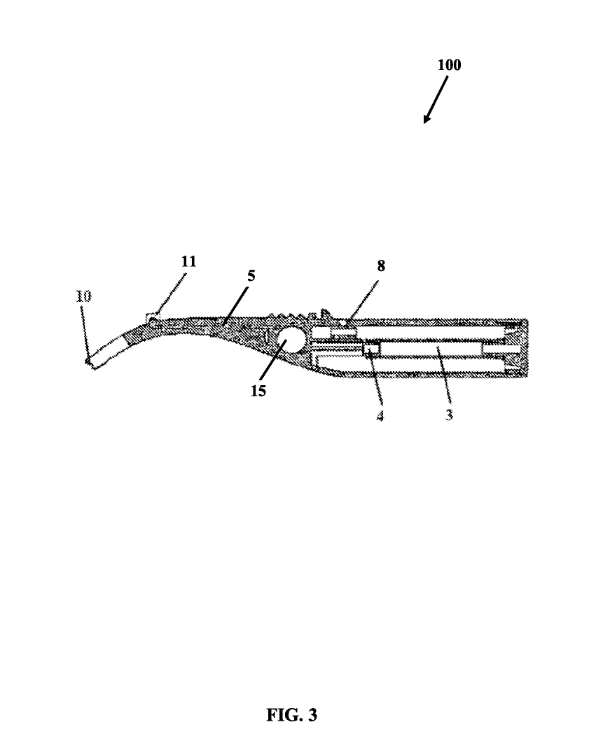

FIG. 3 illustrates a cross sectional view of the dental floss filament holder, according to one embodiment herein. The dental floss filament holder 100 comprises a handle member 5 for supporting the two spaced apart legs 10, a flange 11 provided in the rout of the floss for decreasing the friction between the pieces of floss filament on each other and on the handle member 5 of the dental floss filament holder 100, a spool of floss filament 3, a elastic rubber 4 for preventing an entry of water into the spool 3 of floss filament, segments for conveying the floss filament 8 and a hole 15 for holding the levers as shown in FIG. 3. The spool of floss container 3 is contrived at the ending part of the dental floss filament holder 100 and an elastic rubber 4 blocks the exit part of the floss filament, so prevents water to enter into it when it is washed.

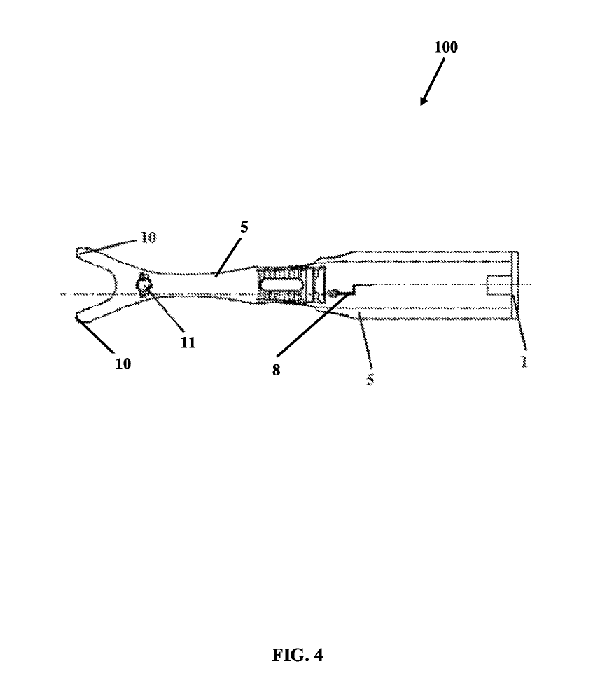

FIG. 4 illustrates a front view of the dental floss filament holder, according to one embodiment herein. The dental floss filament holder 100 comprises a handle member 5 for supporting two spaced apart legs 10, a flange 11 provided in the rout of the floss for decreasing the friction between the pieces of floss filament on each other and on handle member of the dental floss filament holder, segments for conveying floss filament 8, a guide hole for holding the levers and a cap 1 for enclosing the spool container as shown in FIG. 4.

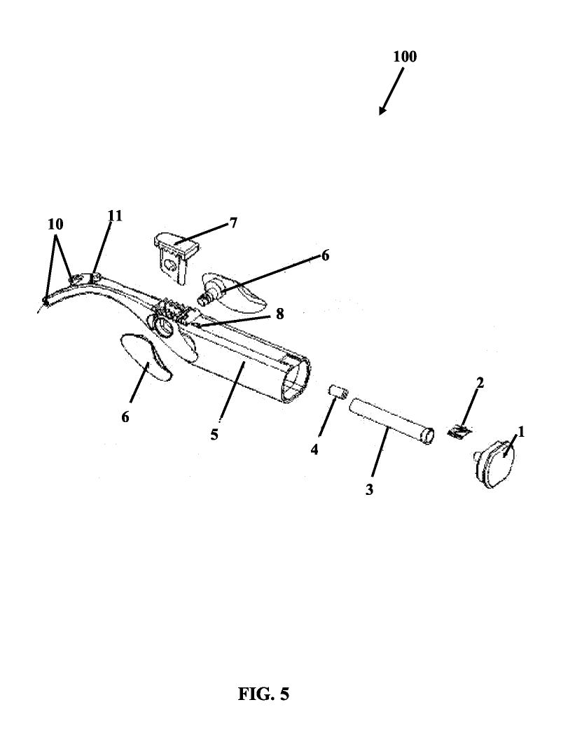

FIG. 5 illustrates an exploded perspective view of the dental floss filament holder, according to one embodiment herein. The dental floss holder 100 comprises a floss filament for removing the tiny food particles from a space between the teeth, at-least two spaced apart legs 10 for holding a floss filament, a handle member 5 for supporting the two spaced apart legs 10, a spool container 3 for securing the spool of floss filament, at-least two levers 6 for holding and releasing the floss filament, a dispenser 7 for dispensing floss filament from the spool 3, a plurality of segments 8 on the handle member 5 for conveying the floss filament, at-least one groove at the junction of two legs on the handle member 5 for passing the floss filament, a metal blade 2 for cutting the consumed floss filament, an elastic rubber 4 for preventing water from entering the floss filament while washing, a cap 1 for enclosing the spool container and a flange 11 provided in the rout of the floss for decreasing the friction between the pieces of floss filament on each other and on handle member of the dental floss filament holder.

According to an embodiment herein, the components have the capability of being separated and washed independently and individually.

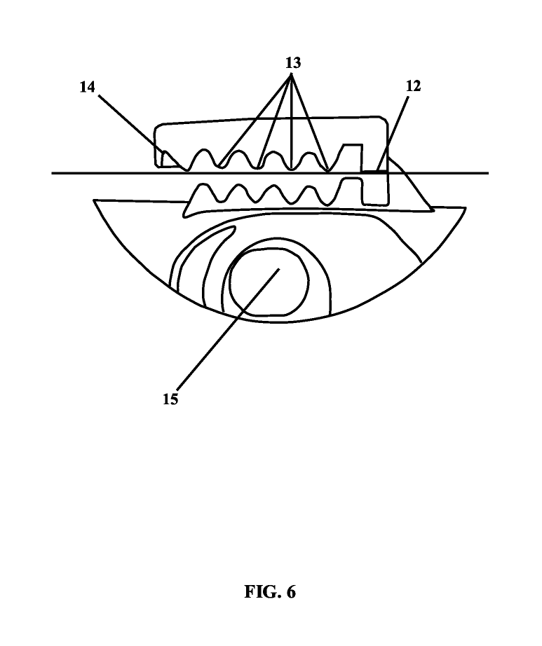

FIG. 6 illustrates a cross sectional view of the dispenser of the dental floss filament holder, according to one embodiment herein. The dispenser of the dental floss filament holder comprises a floss filament holder 12 for holding the floss filament, one or more pullers 13 for pulling the floss from the spool of floss filament, one or more grooves 14 for leading the floss filament and a guiding hole 15 for holding the levers. When the lever of the dental floss filament holder is rotated in an anticlockwise direction, the floss filament holder rises upward and releases the floss filament for replacing the consumed floss filament with the new floss filament. One or more pullers 13 pulls the fresh/new floss filament from the spool container and one or more grooves 14 leads the floss filament. The consumed floss filament is then cut through the metal blade by rotating the lever in a clockwise direction.

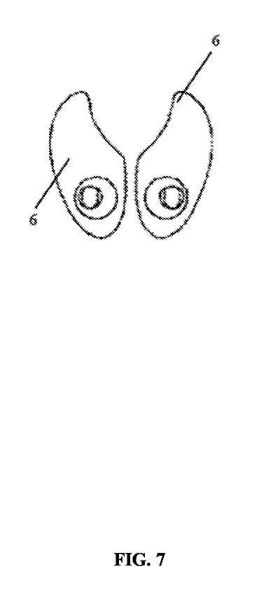

FIG. 7 illustrates a front perspective view of the levers of the dental floss filament holder, according to one embodiment herein. The dental floss filament holder comprises a pair of levers 6. The levers 6 of the dental floss filament holder are non-concentric spheres provided on the sides of the dispenser for applying an excessive pressure with a little force. The levers 6 of the dental floss filament holder turn a rotational movement into a linear movement through 180 degrees rotation leading to the up and down movement of the dispenser. The levers 6 of the dental floss filament holder are rotated in an anticlockwise direction to release the floss filament for replacing the consumed floss filament with the new floss filament.

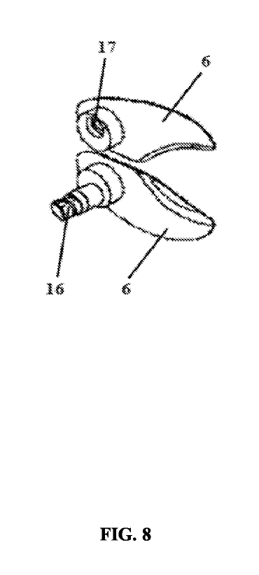

FIG. 8 illustrates a side perspective view of the levers of the dental floss filament holder, according to one embodiment herein. The dental floss filament holder comprises a pair of levers 6. One of the levers comprises an elongated bolt like structure 16 on the inner surface and the other lever comprises a nut like structure 17 on the inner surface as shown in FIG. 8. The elongated bolt like structure 16 of one of the levers is passed through the guide hole provided in the dispenser and the outer edge of the elongated bolt like structure 16, which projected put from the other side of the dispenser, is fixed to the nut like structure 17 of the other lever. The levers 6 of the dental floss filament holder are rotated in an anticlockwise direction to release the floss filament for replacing the consumed floss filament with the new floss filament.

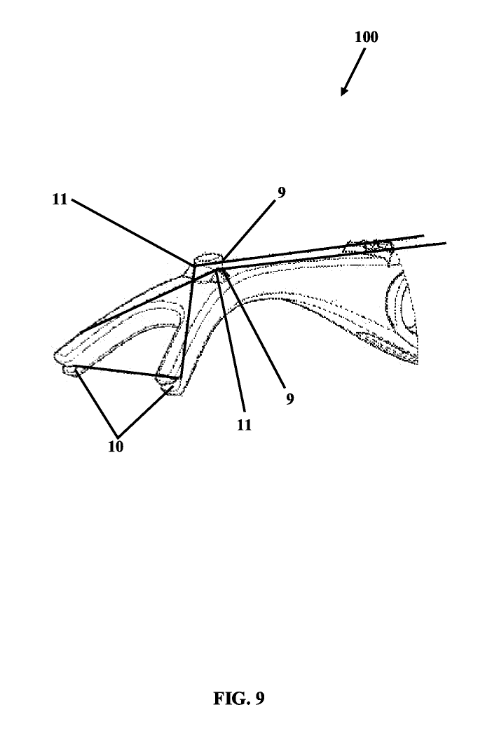

FIG. 9 illustrates a side perspective view of the legs holding floss filament, according to one embodiment herein. The dental floss filament holder 100 comprises grooves 9 at the junction of two legs 10 on the handle member for passing the floss filament and flanges 11 in the rout of the floss for decreasing the friction between the pieces of floss filament on each other and on the handle member of the floss holder.

According to an embodiment herein, the dental floss filament holder 100 comprises two flanges 11 in the rout of the floss. The flanges 11 decrease the friction between the pieces of floss filament on each other and also on the body of the handle member as they are pulled and hence the pieces of floss filament are fixed thoroughly.

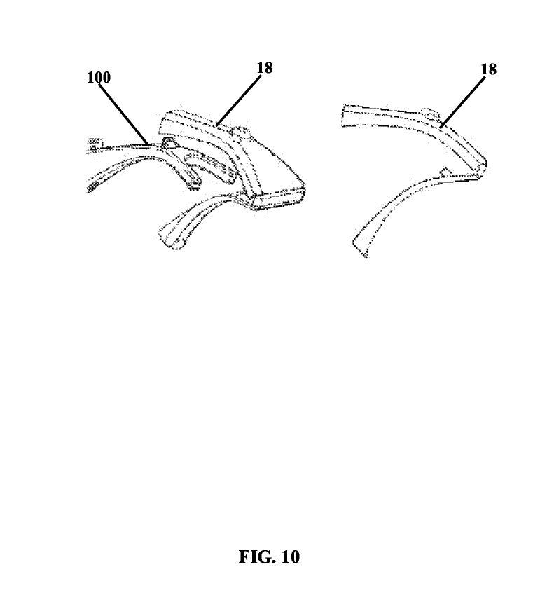

FIG. 10 illustrates a side perspective view of the cover of the dental floss filament holder, according to one embodiment herein. The dental floss filament holder 100 comprises a cover 18 for securing floss filament when not in use. The cover 18 comprises a hinge arrangement between the arms to enable flexibility in arms. The lower arm includes an elongated hook in the inner surface to lock the cover on the dental floss filament holder 100 as shown in FIG. 10. The upper arm of the cover comprises a protrusion on the inner surface to secure the flanges of the dental floss filament holder 100, when the cover is placed over the dental floss filament holder 100 as shown in FIG. 10.

According to an embodiment herein, the dispenser of the dental floss filament holder further comprises at-least two types of cogs including the guiding groove and lever hole. The holding cog comprises a small angle thereby the floss filament movement is prevented. The dispenser further comprises cogs with larger angles thereby the floss filament is pulled and is firmed as the dispenser comes down. The guiding groove prevents the floss filament from falling down from the cogs.

According to an embodiment herein, the dental floss filament holder further comprises a releasing lever. The releasing lever is in the form of two non-concentric spheres thereby the dispenser comes up through 180 degree rotation.

According to an embodiment herein, the lever that fixes the floss filament that is much alike the releasing lever thereby the dispenser comes down with a rotation in the direction opposite to that of the releasing lever.

According to an embodiment herein, the spool of the floss filament includes 80 meters of floss filament.

The various embodiments herein provide a dental floss holder for holding the dental floss filament. The dental floss filament holder enables an ease of flossing by the users of all ages and prevents a contamination of mouth due to the hands. The dispenser of the dental floss filament holder uses only 1.5 cm of the floss filament length for holding and pulling it. The dental floss filament holder herein consumes only 10 cm to 15 cm of floss filament in each time of usage. The dental floss filament holder is easy to use especially for children and also improves the efficiency of dental floss. The dental floss filament holder reduces the hand contact with the floss and avoids the need of entering the hand into the mouth which may lead to disease. The dental floss filament holder holds the floss filament in the mouth firmly and decreases the possibility of being ruptured and consumes lower amount of floss filament comparing to the usage of floss with hands.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A dental floss holder comprising:
a floss filament;
at least two spaced apart legs for holding the floss filament;
a handle member for supporting the at least two spaced apart legs;
a spool container for securing a spool of floss filament;
at least two levers for holding and releasing the floss filament;
a dispenser, and wherein the dispenser comprises a floss filament holder for holding the floss filament, one or more pullers for pulling the floss filament from the floss filament holder, one or more grooves for leading the floss filament and a guiding hole for holding the levers;
segment on the handle member for conveying the floss filament;
at least one groove at a junction of the two legs on the handle member for passing the floss filament;
a metal blade for cutting a used floss filament and wherein the metal blade is made of stainless steel;
an elastic rubber for preventing water from entering the floss filament;
a cap for enclosing the spool container;
at least two flanges along a route of the floss filament for decreasing a friction between the pieces of floss filament on each other and wherein the two flanges are provided on the handle member of the floss holder;
a cover for securing the dental floss holder when not in use; and
wherein one lever is rotated in an counterclockwise direction to release the floss filament for replacing the used floss filament with a new floss filament and wherein the used floss filament is cut with the metal blade by rotating one lever in a clockwise direction.

2. The dental floss holder according to claim 1, wherein the elongated handle member is provided with the two spaced apart legs and wherein the legs are designed with a size for a holding by a user and wherein the legs are inclined at an angle to a longitudinal plane running along a length of the handle member to allow a positioning of a taut floss between spaces in the users teeth.

3. (canceled)

4. The dental floss holder according to claim 1, wherein the levers are provided respectively on two sides of the dispenser for applying an excessive pressure with a little force, and wherein the leavers on the two sides are not arranged concentrically.

5. The dental floss holder according to claim 1, wherein the levers are rotated through 180 degrees to turn a rotational movement into a linear movement thereby leading to an up and down movement of the dispenser.

6. The dental floss holder according to claim 1, wherein the levers comprises:
a lifting lever rotating in a counterclockwise direction and a lowering lever rotating in a direction which is contrary to a dispenser movement direction, and wherein a new floss filament is released to replace the used floss filament as the used floss filament pulls the new floss filament when the lifting lever is rotated in counterclockwise direction, and wherein the new floss filament comes down in the direction contrary to the dispenser movement direction when the lowering lever is rotated.

7. The dental floss holder according to claim 1, wherein the floss filament holder is moved down to engage a cog holding the floss filament to prevent a reattachment of the floss filament to the spool, when the levers are rotated.

8. The dental floss holder according to claim 1, wherein the dispenser further comprises one or more puller cogs for firming and pulling the floss filament.

9. The dental floss holder according to claim 1, wherein the dispenser further comprises a plurality of guiding grooves for preventing a falling down of the floss filament from the cogs.

10. (canceled)

11. (canceled)

12. The dental floss holder according to claim 1, wherein one of the two leavers comprises an elongated bolt like structure on an inner surface, and other leaver comprises a nut like structure on an inner surface.
